(19) United States
(12) Patent Application Publication
(10) Pub. No.: US 2016/0334780 A1
(43) Pub. Date: Nov. 17, 2016

(54) MASS CUSTOMIZED MANUFACTURE OF A WEARABLE ARTICLE

(71) Applicant: LIM Innovations, Inc., San Francisco, CA (US)

(72) Inventors: Thomas M. Dair, Lafayette, CA (US); Andrew C. Pedtke, San Francisco, CA (US); Robert Adam Geshlider, San Francisco, CA (US); Garrett Ray Hurley, San Francisco, CA (US)

(21) Appl. No.: 15/147,006

(22) Filed: May 5, 2016

Related U.S. Application Data
(60) Provisional application No. 62/160,528, filed on May 12, 2015.

(51) Int. Cl. G05B 19/4099; G05B 15/02

(52) U.S. Cl. CPC G05B 19/4099; G05B 15/02; B33Y 50/02

(57) ABSTRACT

The technology includes methods and systems for providing a wearable article to a customer, one that conforms to portion of the customer's body. Methods include receiving an acquired digital data set defining a three-dimensional digital profile of the body part; translating the digital set into instructions for fabrication of the wearable article; and sending the instructions for fabrication of the wearable article to a fabrication site. Instructions for fabrication of the wearable article are operable to select from inventories components or materials to be used in the fabrication of the wearable article, and are operable to fabricate or reshape the components or materials through implementation of a rapid manufacturing machine. A finished article assembled therefrom conforms to the body part. In one embodiment, the business entity engaged in the receiving, translating, and sending steps is a service provider; a separate business entity controls a fabrication site that is engaged in the selecting and the fabricating or modifying steps.

### CROSS-REFERENCE TO RELATED APPLICATIONS

This application claims priority to U.S. Provisional Patent Application No. 62/160,528 entitled “Mass Customized Manufacture of a Wearable Article,” filed May 12, 2015. The entirety of the above application is herein incorporated by reference.

### TECHNICAL FIELD

The technology relates a mass customized approach to manufacturing wearable articles or medical devices.

### INCORPORATION BY REFERENCE

All publications and patent applications identified in this specification are herein incorporated by reference to the same extent as if each such individual publication or patent application were specifically and individually indicated to be so incorporated by reference.

### BACKGROUND

Some articles, such as wearable articles and medical devices ideally may be fabricated by mass manufacturing systems and methods that deliver economies of scale with an associated low cost. However, there can also be a demand in the market for wearable articles or medical devices that are custom fitted to an individual customer or patient. Custom-fitted articles are typically made one-by-one, the very antithesis of mass scale and low cost. In spite of the desirable aspects of custom-fitted articles, the cost of mass produced articles commonly establishes the low cost of mass produced articles in the minds of consumers as an appropriate cost. Mass customization fabrication systems and methods try to resolve this dilemma and deliver custom-fitted articles at costs that are not grossly at odds with the costs of mass produced products, which are produced in a limited range of sizes and shapes.

### SUMMARY OF THE TECHNOLOGY

Embodiments of the technology include methods and systems for fabricating a wearable article to a customer, wherein the wearable article substantially conforms to at least a portion of a body part of the customer. The term customer is intended to be interpreted broadly; a customer may be a patient or a client, anyone seeking a custom-fitted wearable article. Typically a customer is a human being, but, as seen in one example described below, a customer may include an animal.

In one aspect, a fabrication method may involve: receiving an acquired digital data set defining a three-dimensional digital profile of the portion of the body part; translating the digital set into instructions for fabrication of the wearable article; and sending the instructions for fabrication of the wearable article to a fabrication site. The instructions for fabrication of the wearable article, per this method embodiment, are operable to select one or more components or materials from one or more inventories to be used in the fabrication of the wearable article, and are operable to fabricate or reshape the components or materials through implementation of one or more rapid manufacturing machines such that a finished article assembled therefrom substantially conforms to the portion of the body part. In one embodiment, a business entity engaged in the receiving, translating, and sending steps may be referred to as a service provider. In some embodiments, a separate business entity may control a fabrication site engaged in the selecting, fabricating and/or reshaping steps.

Prior to receiving the digital data set at the fabrication site, embodiments of the method further include profiling the portion of the body part at a retail site, to acquire the digital data set. Embodiments of this method may further include sending the digital data set that profiles the portion of the body part to a service provider, who then receives the data set as above.

The location, ownership, or operating control of the fabrication site may vary in different embodiments of the method. For example, the fabrication site may be a retail site, a site remote from the retail site, a site owned by a wearable article brand company, or a mobile site. The retail site, remote site, or mobile site may be owned or under operation control by a brand manufacturer of wearable articles, or it may be independently owned or controlled.

Embodiments of the method may further include reshaping the components or materials, according to the instructions. Embodiments of the method may further include assembling the one or more components or materials into a complete wearable article that substantially conforms to the body part of the customer. The assembling step may occur at any of several sites. For example, assembling the one the one or more components or materials into a complete wearable article that substantially conforms to the body part of the customer may occur at any of the retail site, the remote site, or the mobile site. In a final step, embodiments of the method include delivering the complete wearable article to the customer, which typically occurs at the retail site.

In some embodiments of the method, the rapid manufacturing machine is operable by a CNC machine, operating from manufacturing instructions that specify a configuration of an actuatable pin-based surface. In other embodiments, the rapid manufacturing machine may include an actuatable pin-based surface, in which each of the pins is independently actuatable to by a motor proximate the pin. Embodiments of the rapid manufacturing machine used by the method typically include an actuatable surface capable of complying with (or fulfilling or following) the instructions to form a surface that is conformal or complementary to the three-dimensional digital profile of the portion of the body part. In particular embodiments of the method, the instructions are modifiable by biomechanically informed input that directs divergence from a reshaped surface that is strictly conformable or complementary to one that is biomechanically appropriate for the wearer.

In another aspect, a system is described for providing a wearable article to a customer, where the wearable article substantially conforms to at least a portion of a body part of the customer. In one embodiment, the system includes: an inventory of components or materials for assembling the wearable article, based at least in part on a digital profile of at least the portion of the body part; a data storage device for storing instructions for selecting customer-specific wearable article components from the inventory and operated by a service provider; and a processor configured to execute the instructions to perform a method and operated by a service provider. The performed method includes receiving a digital data set defining a three-dimensional digital profile of the portion of the body part at a fabrication site; and translating the digital set into instructions for fabricating the wearable article. Based on the fabrication instructions, the method further includes selecting one or more components or materials from one or more inventories to be used in fabricating the wearable article. Further based on the fabrication instructions, the method may further include fabricating or reshaping the components or materials with one or more rapid manufacturing machines, such that a finished article assembled therefrom substantially conforms to the portion of the body part.

In some embodiments, the method performed by the system, prior to receiving the digital data set at the fabrication site, may further include profiling the portion of the body part at a retail site, to acquire the digital data set, and then sending the digital data set to the service provider. In various embodiments, the fabrication site may be a retail site, a remote site, a site owned by a wearable article brand, and/or a mobile site. In these embodiments, the retail site, remote site, and/or mobile may be operable by a brand manufacturer of wearable articles. In other embodiments, the retail site, remote site, and/or mobile site may be independently owned or operated by a party other than the brand manufacturer.

Embodiments of the rapid manufacturing machine used by the system may include an actuatable surface capable of complying with the instructions to form a surface that is conformal or complementary to the three-dimensional digital profile of the portion of the body part. In some embodiments, the rapid manufacturing machine is operable by a CNC machine, operating from manufacturing instructions that specify a configuration of a an actuatable pin-based surface. In other embodiments, the rapid manufacturing machine may include an actuatable pin-based surface, in which each of the pins is independently actuatable by a motor proximate the pin. In particular embodiments, the instructions are modifiable by biomechanically informed input that directs divergence from a reshaped surface that is strictly conformable or complementary to one that is biomechanically appropriate for the wearer.

In some embodiments of the system, the method performed by the system further includes assembling the one or more components or materials into a complete wearable article that substantially conforms to the body part of the customer. In these embodiments, assembling the one or more components or materials into a complete wearable article that substantially conforms to the body part of the customer may occur at a retail site, a remote site, or a mobile site. In some embodiments, a final step of the method performed by the system may involved delivering the complete wearable article to the customer.

These and other aspects and embodiments are described in more detail below, in reference to the attached drawing figures.

### BRIEF DESCRIPTION OF THE FIGURES

FIG. 1 is a schematic diagram of a system of mass customized production of individually customer-fitted wearable articles, according to one embodiment;

FIG. 2 is a pictographic diagram of a method of producing custom fitting wearable articles and their rapid manufacture at a retail site, according to one embodiment;

FIG. 3 is a pictographic diagram of a method of producing custom fitting wearable articles and their rapid manufacture at a remote site, according to one embodiment;

FIG. 4 is a pictographic diagram of a method of producing custom fitting wearable articles and their rapid manufacture at a facility owned and/or operated by a wearable article brand company, according to one embodiment;

FIG. 5 is a pictographic diagram of a method of producing custom fitting wearable articles and their rapid manufacture at a mobile site, according to one embodiment;

FIG. 6 is a flow diagram of a method of producing custom fitting wearable articles and their rapid manufacture at a facility owned and/or operated by a wearable article brand company

FIG. 7 is a flow diagram of a method of producing custom fitting wearable articles and their rapid manufacture, according to one embodiment;

FIG. 8 is a flow diagram of a method of producing custom fitting wearable articles and their rapid manufacture, according to an alternative embodiment;

FIG. 9 is a flow diagram of a method of producing custom fitting wearable articles and their rapid manufacture, according to another alternative embodiment; and

FIG. 10 is a flow diagram of a method of producing custom fitting wearable articles and their rapid manufacture, according to another alternative embodiment;

### DETAILED DESCRIPTION OF THE TECHNOLOGY

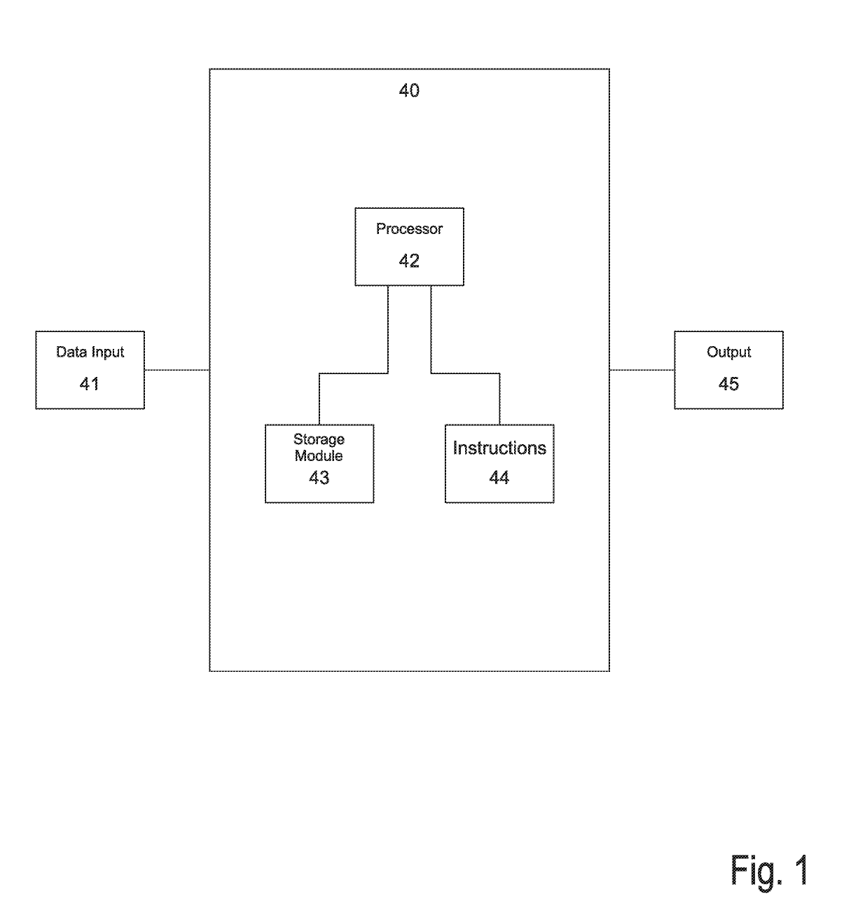

FIGS. 1-10 depict various embodiments of a mass customization systems and methods for manufacturing customized wearable articles. These systems and methods include both the technology of rapid manufacturing machines, as well as business and manufacturing relationships that support mass customization strategies and create efficiencies in the market.

### Rapid Manufacturing Machines

The term “rapid manufacturing machines” refers generally to machines that are faster than conventional manufacturing machines and that use digital input in some way. These machines typically remove the need for one or more conventional manufacturing tools and their associated costs, and thus they often add significant levels of flexibility in design, are quickly deployable, and minimize standing inventories and obsoleted components. These advantages all contribute to “rapidity” and resource efficiencies. Typical examples of rapid manufacturing machines include 3D printing devices, laser sintering machines, and the like. In the described system and method embodiments, rapid manufacturing machines are typically used for replicating a contour of a portion of a body onto an article or a portion or component thereof. Typically, the replicated contour is actually a complement of the original contour on the body; for example, a convex body contour is replicated as a complementary concave contour.

Rapid manufacturing machine embodiments, as referred to herein, include 3D printers and various forms of an actuated surface technology. These actuated surface devices can replicate a known or existing model contour onto a manufactured article or a component thereof, such that the manufactured article is individually customized to fit the model. Embodiments of these rapid manufacturing machines may be referred to as a reconfigurable surface apparatus, a reconfigurable pin tooling device, a pin jig, or any similar term. The rapidity of manufacturing machines in producing wearable articles is in the particular and comparative context of producing individually customized wearable articles, which by conventional approaches would be made in a one-by-one, artisan-like manner, typically involving a highly intensive use of time, money, material resource, and space.

Some embodiments of an actuated surface technology that are provided herein are capable of bending pliable components. Some embodiments of the actuated surface technology are configured to contour settable materials. Some particular embodiments include thermal reforming apparatuses, and implementing methods are for replicating a known contour onto a thermoplastic article. In one embodiment, a thermal reforming apparatus replicates a contour of a body part, such as a residual limb, onto a thermoplastic or thermoplastic-fiber composite article, such as a strut for a modular prosthetic socket. Embodiments of such a modular prosthetic socket are described in U.S. Pat. No. 8,978,224 of Hurley and Williams; further details of prosthetic socket structure and a thermoplastic fiber composite strut included therein are described in U.S. patent application Ser. No. 14/213,788 of Hurley and Williams. An example of an approach to rapid manufacturing of a custom-fitted article is provided in U.S. patent application Ser. No. 14/572,571 of Hurley and Pedtke, filed on Dec. 16, 2014. An example of a rapid manufacturing machine capable of transferring a digital profile of a body part to a fitted wearable article is provided in U.S. patent application Ser. No. 14/731,163, filed on Jun. 4, 2015. All three of these patent publications are hereby incorporated into the present application.

### Wearable Articles

Some embodiments of the technology include wearable articles that can generally considered sporting equipment, but may be perfectly useful in various everyday or working activities. Examples of such wearable articles of manufacture include a helmet, footwear, goggles, eyeglasses, protective padding, a mask, or a shin guard, but the provided technology may be applied to any wearable article where personalized fitting for a customer is sought. What these examples of wearable articles have in common is that at least a portion of the article advantageously has a high degree of conformance (or complementarity) to a portion of the customer's body, and such conformance is important for the functionality of the article. Conformance, as used herein, refers to the shape of a portion of the article being replicative of the shape of the body part. Complementarity refers to the nature of the fit when the article and the body part are placed adjacent to each other, that if the body part surface is considered a “positive,” then the facing aspect of the article is the “negative” or “complement.”

In various embodiments, a “customer” may be either a human being or an animal. Animals have highly individualized body forms, as do people, and any article that needs to fit well in order to optimize performance of the article may be included as an embodiment of the present technology. By way of example, horses have highly individual shapes, and a saddle, to function well, needs to fit the horse well. In this instance, the main structural element of a saddle is the “tree,” commonly formed of plastic, and intended to fit the back of the horse extremely well, and, consequently, distribute the weight of a rider well on the back of the horse.

A customer is to be understood broadly as potential user or recipient of a custom-fitted wearable article. By way of example, a customer may be a client, a patient, or an animal. Typically, a customer engages an embodiment of the system provided herein at a retail brick and mortar site, but in some embodiments, a customer may engage the system electronically, via a web interface or by telephone. Additionally, a customer may be a patient, in which case the engagement may occur in a medical setting.

Typically, at least one portion or one surface of a fitted wearable article is relatively hard and capable of maintaining a shape imparted by a rapid manufacturing machine, as is characteristic of metals and some plastics, particularly thermoplastics and thermoset plastics. Other portions or surfaces of the article may be soft and compliant, as can be characteristic of fabrics, leather, soft goods, some plastics, and textiles. Wearable articles may also include medical devices, such as orthotic, prosthetic, or exoskeletal devices, as well as implantable devices. Inasmuch as orthotic devices can be braces or body part conforming devices, such braces or a body part conforming device may also be included as wearable articles, as defined herein. Accordingly, body conforming devices may be included as elements in supportive aspects of articles such as beds, cots, wheelchairs, walkers, and the like.

Wearable articles, as referred to herein, generally relate to devices or clothing that are characterized by a high degree of fit for the individual customer, and typically include contours or contoured portions that complement contoured portions of the body that the device or article of clothing needs to fit. The necessity of high fidelity personal fit for such articles is not a matter of mere vanity or fashion, but rather of comfort, which is closely linked to functionality.

### Mass Customization

The technology described herein as an example of a mass customization approach to manufacturing articles. Mass customization refers to systems and methods that can deliver customized products at a scale and at an economy of scale that approaches the scale and economy of products produced in a conventional range of sizes and options. Customization that actually is specific to a patient or customer is desirable when a high fidelity fit is critical for functioning of the product. In some embodiments, a high fidelity fit may be one that is modified according to factors not immediately obvious from a 3D profile alone, such as biomechanical factors, or changes in the static 3D form that occur when the body is in motion. Accordingly, algorithms that direct rapid machine operations, as provided herein, may include algorithmic elements that are directed to modifying otherwise strictly conformal shapes into biomechanically appropriate variations of such conformal shapes. By way of example, drawing from a prosthetic socket context, attributes of biomechanically sensible modifying algorithms may include considerations of limb movement, whole body movement, the amount of weight bearing to be supported by the prosthetic socket, and individual characteristics of the residual limb, particularly the distal end of the residual limb.

These attributes of a biomechanically appropriate fit are useful in medical devices and in wearable articles used in high performance athletics or high performance occupations, such as in the military, law enforcement, forestry, construction, aeronautics, mountaineering, underwater work, and the like. Systems that can manufacture custom-fitted surfaces on articles quickly and accurately may be highly advantageous.

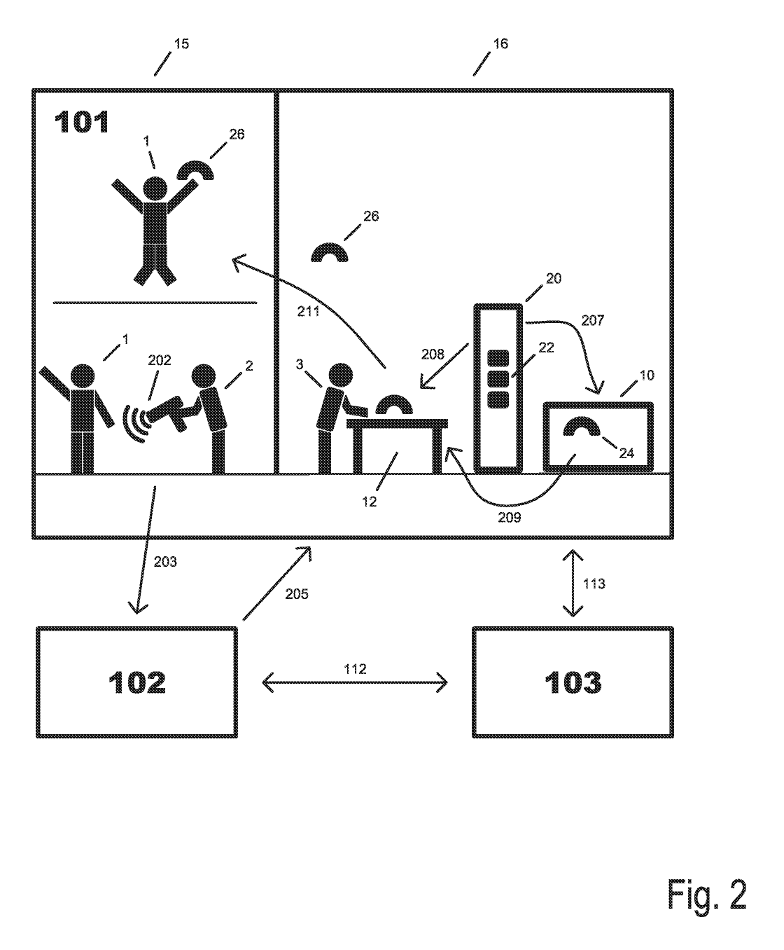

FIG. 1 is a schematic diagram of a system 40 for providing a wearable article to a customer. A description of mass customization and a recitation of technologies that underlie implementation of mass customization as directed to delivering a custom-fitted wearable article is described above. Data input 41 to system 40 may include, for example, a digital profile of at least a portion of a body part of customer, for which an individually assembled and configured wearable article will be fabricated, as described in detail above. (See FIGS. 2-5 for depictions of a customer 1, rapid manufacturing machines 10, inventories 20, and a retail site 101.)

System 40 includes a processor 42, a storage module 43, and instructions 44 that drive output 45 in the form of implementing method steps. Instructions 44 are put into system 40 in the form of rules and algorithms, as may be derived from component specifications, and from accumulated empirical data. Data input 41, typically sent from a retail site 101 (see FIGS. 2-5), in the form of a digital data set that profiles a body part of customer 1 is received by system 40 and stored in the storage module 42, along with identifying attributes that allow retrieval, so that instructions 44 can engage the data set and generate customer-specific output 45. Typically, output 45 relates to operating instructions that identify or select appropriate wearable article components or materials from inventories 20, registering the profile data on a wearable article template that includes all component specifications, modifying or reshaping selected components as may be needed on one or more rapid manufacturing machines 10, assembling components into a complete wearable article or packaging components as a kit. Instructions may further include directions to ship any of the components, kits, or fully assembled wearable articles back to retail site 101.

Referring now to FIGS. 2-5, several business entities may be cooperatively engaged in using system 40, with operations distributed over several sites. These entities may include a retail site 101, a service provider 102 that owns the algorithms and intellectual property that enable functional integration of the various business entities and operate rapid manufacturing machines, and a branded article manufacturing company 103. The service provider 102 typically develops and updates algorithms and the one or more software applications that translate acquired data sets of body part profiles into operational instructions that instruct the operations of rapid manufacturing machines 10. Rapid manufacturing machine 10 is generally capable of creating articles with complex predetermined contours. As used by embodiments of the technology described herein, these predetermined contours typically are portions of a human body, and the contours replicated in an article produced by rapid manufacturing machine 10 are either that contour or its complement. Rapid manufacturing machines 10 often use an array or an actuated surface formed by movable pins, and can therefore be referred to as reconfigurable pin tool machines. One example of rapid manufacturing machine 10 particularly applicable to forming contoured medical devices from thermoplastic substrates is described in U.S. Provisional Patent Application No. 62/007,742.

In some embodiments, each of the business entities (retailer, service provider, branded wearable article manufacturer, factory) is independently owned and operated. In other embodiments, branded article manufacturing company 103 may own or have some operating control over retail site 101. Typically, service provider 102 does not own the retail site 101, although it may, in some embodiments. In some embodiments, service provider 102 and branded article manufacturing company 103 are separate and independent entities, although they work cooperatively. For example, they may work under the terms of a joint venture arrangement, or they may work cooperatively in an arrangement wherein service provider 102 is a licensor of proprietary information and intellectual property to branded article manufacturing company 103, operating as a licensee. The business relationship or cooperative manufacturing relationship between service provider 102 and branded article manufacturing company 103 is represented by label 112.

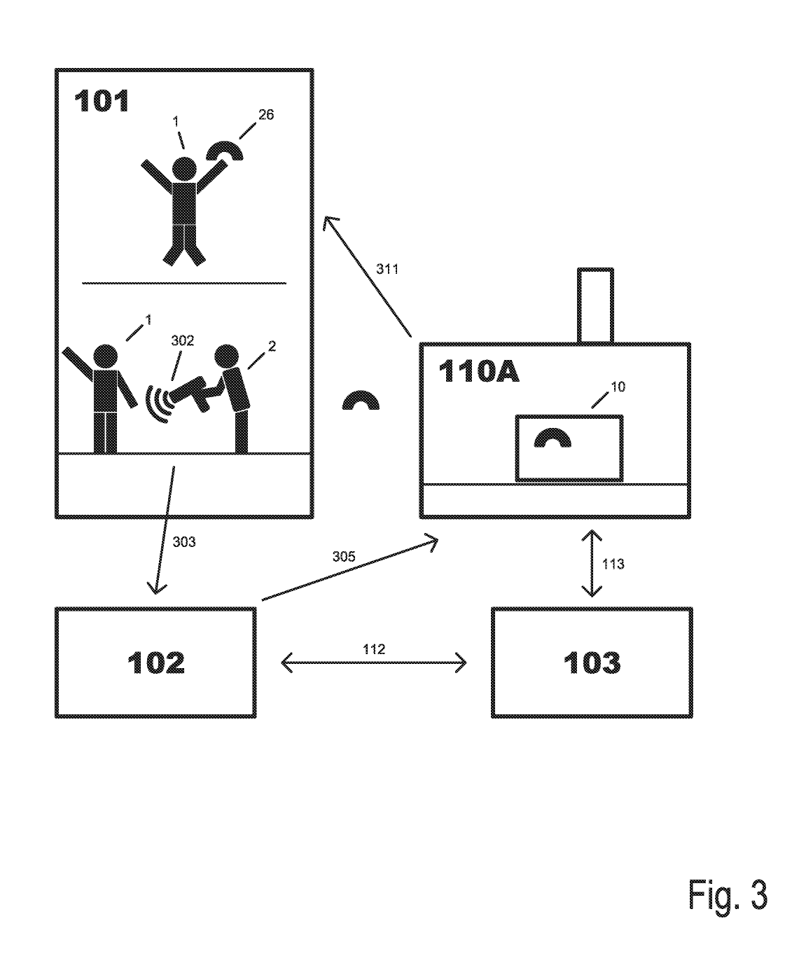

Referring to FIGS. 3-5, fabrication of wearable articles occurs in a factory or fabrication site 110, which may be housed in various locations. For example, fabrication site 110A may be remote from either retail site 101 or the wearable article brand company, a fabrication site 101B may be owned and operated by the wearable article brand company 103, a fabrication site may be disposed within retail site 101, or fabrication site 110M may be configured as a mobile van or truck.

The methods depicted in FIGS. 2-5 may include acquiring a body portion profile of a customer and packaging that profile as a data set, translating or transforming the profile data set into operable instructions for a one or more rapid fabrication machines, and sending that data set from its site of origin to a fabrication site, where it is received and implemented. At the fabrication site, based on instructions, one or more components or materials are selected from one or more inventories. These components or materials are then rendered by the rapid manufacturing machines 10 into components that are suitable for assembly into a final product, one that conforms to the body part originally profiled. In a next step, components and materials are assembled into the final product, and delivered to the customer.

The acquisition of a data set that captures the profile of at least a portion of a customer's body part, in some embodiments, occurs at a retail site 101. U.S. Provisional Patent App. No. 62/007,742 describes approaches of acquiring digital data that profile a body part for which a wearable article is to be fabricated. Acquiring such a data set may occur by any suitable approach, including any one or more of scanning, photographing, casting, mapping with a three-dimensional point reference device a three-dimensional digital or physical representation of the residual limb, or by manual measurement. In a particular approach to acquiring digital data that characterizes a body part, photogrammetry may be applied. Photogrammetry is the practice of making measurements from photographs, especially for recovering the exact positions of surface points on a target object. The application of photogrammetry to deriving a useful 3D data of a target object such as a body part, as applied to fabricating an individualized, custom-fabricated wearable article, includes the use of multiple conventional 2D photographs of a residual limb. In some embodiments, video data may be applicable to the method. The photogrammetric process is optimized by using a sufficiently large number of photographs, having the photographs taken from a sufficiently dense distribution of 3D perspectives, having a sufficiently dense set of unique markers on the target object, and/or having a sufficiently dense number of unique markers in the background.

In brief, the technology is agnostic with regard to the source of the data set; the only requirement is that the data be of sufficient quality and density that it can provide effective instructions for the fabrication of a wearable article that conforms to the appropriate body part of the customer with a high degree of fidelity.

Methods of mass customization, as shown in FIGS. 2-5, may differ from each other based on where manufacture and/or fabrication of the mass customized article occurs. FIGS. 2-5 are pictographic depictions of variations on methods of fabricating a wearable article for a customer, in which the wearable article substantially conforms to at least a portion of a body part of the customer.

FIG. 2 depicts a mass customization method and system embodiment, in which both manufacturing and assembly occur at retail site 101. Retail site 101 includes a facility for customer engagement and a fabrication facility. Thus, at retail site 101 a customer 1 and a retail technician 2 meet in the customer service facility, and technician 2 acquires (step 202) a data set that profiles a body portion of customer 1. Once a digital data set profiling the customer has been acquired, it is sent (Step 203) to service provider 102 for processing by system 40. There, it is received and becomes data input 41, as shown in FIG. 1. In related embodiments (not shown), a customer may be able to acquire a data set at home, making use of photographs, video, or manual measurements, and then send the data either to the retail site 101 or to the service provider 102.

Service provider 102 has an operating arrangement or agreement 112 with branded wearable article manufacturer and marketer 103, which, in turn, has a manufacturing agreement 113 with retail entity 101. This arrangement may include terms that relate to matters such as cooperating with the logistics of components, or customer orders, maintaining inventory, and/or the like.

Within system 40 of service provider 102, input is processed into output 45, which includes manufacturing instructions 44. Service provider 102 then sends (Step 205) manufacturing instructions to the fabrication facility within retail site 101, which includes an inventory 20 of parts or components 22 that are required for fabrication of a custom-fitted wearable article 26. The fabrication facility may also include an assembly station or facility 12.

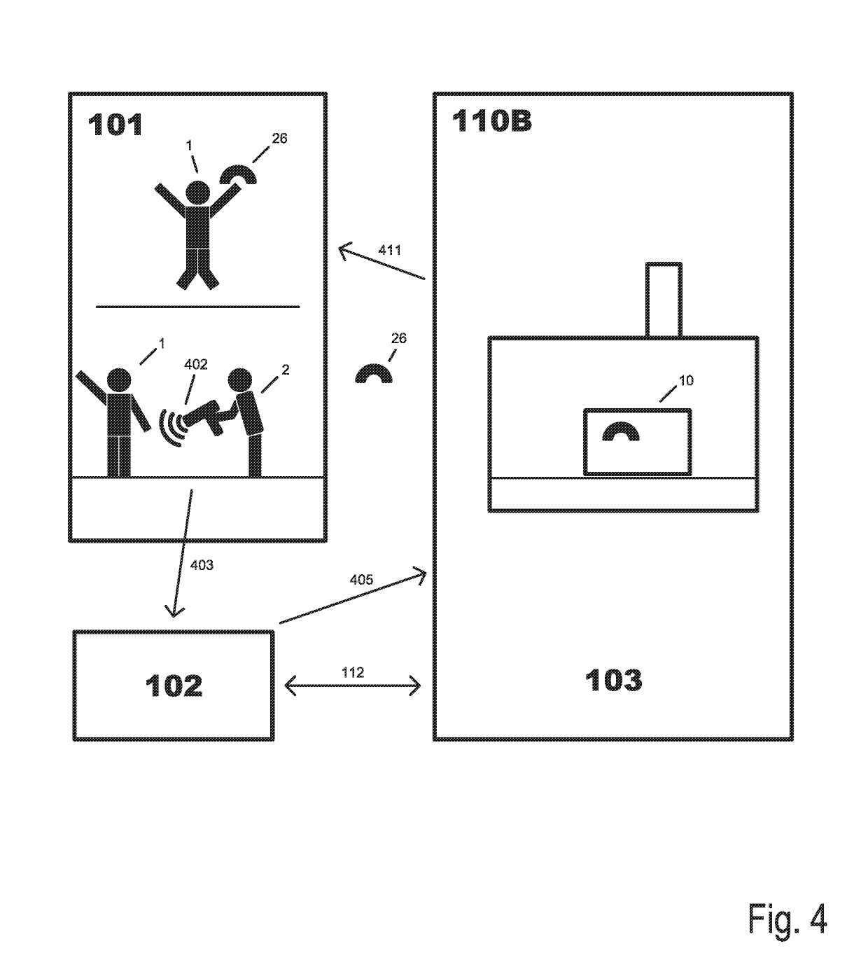

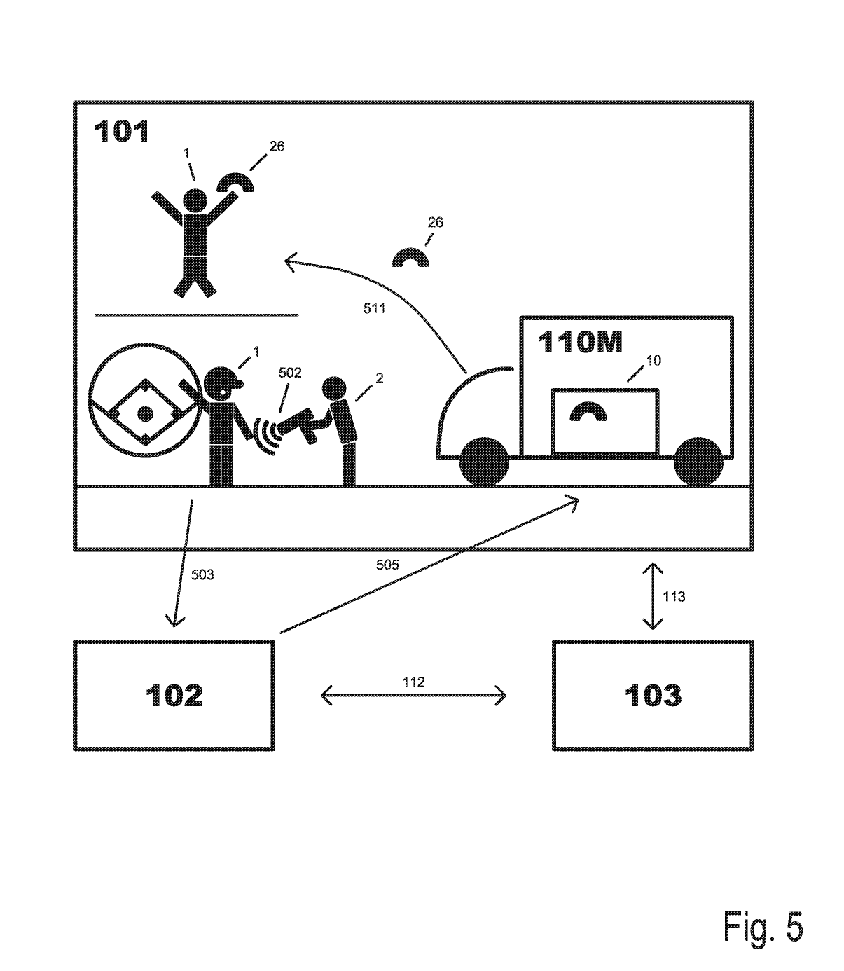

Within the fabrication facility, components 22 that are appropriate, per manufacturing instructions, are conveyed into a rapid manufacturing machine 10 for processing into a desired form. Some components and materials 22, selected per manufacturing instructions, may not need to be subjected to processing by rapid manufacturing machine 10, and may be sent 208 directly to an assembly station 12. Components 24 that have been altered or reformed by rapid manufacturing machine 10 are then conveyed 209 to assembly station 12, where they, along with other components, are assembled into a fully assembled custom fit wearable article 26. Next, and finally, completed article 26 is conveyed (Step 211) to the customer service facility, where it is delivered to customer 1. The fabricating machines and operations described for this embodiment, where the fabrication facility is located in retail site 101, are substantially the same in other embodiments described below (facility 110A of FIG. 3, Facility 110B of FIG. 4, and mobile facility 110M of FIG. 5).

FIG. 3 depicts a mass customization method and system embodiment where manufacturing and assembly occur at a central fabrication site 110A. Embodiments of this site 110A are typically remote from the retail site 101, and may be owned, for example, by a third party that is operating under an agreement with a brand wearable article company 103.

At retail site 101 a customer 1 and a retail technician 2 meet in the customer service facility, and technician 2 acquires 302 a data set that profiles a body portion of customer 1. Once a digital data set profiling the customer has been acquired, it is sent to service provider 102 and there received (Step 303) for processing by system 40. There, the digital data set becomes data input 41, as shown in FIG. 1.

Service provider 102 has an operating arrangement or agreement 112 with branded wearable article manufacturer and marketer 103, which, in turn, has an operational agreement or cooperative arrangement 113 with retail entity 101, as noted above. This arrangement may include, merely by way of example, cooperating with the logistics of components, or customer orders, maintaining inventory, and/or the like.

Within system 40 of service provider 102, input is processed into output 45, which includes manufacturing instructions 44. Service provider 102 then sends (Step 305) manufacturing instructions to the fabrication facility remote fabrication site 110A.

Fabrication site 110A includes inventory 20 of parts or components 22 (as shown in FIG. 2) that are required for fabrication of a custom-fitted wearable article 26. Within fabrication facility 110A, components 22 that are appropriate per manufacturing instructions are conveyed into a rapid manufacturing machine 10 (see FIG. 2) for processing into a desired form. Fabrication and assembly steps within fabrication facility 110A are substantially the same as those described in the fabrication facility, as shown in FIG. 2.

Through the combined activity of rapid manufacturing machinery and product assembly within fabrication facility 110A, a complete article 26 is manufactured and then conveyed (Step 311) to the retail facility 101, where it delivered to customer 1.

FIG. 4 depicts a mass customization method and system embodiment where manufacturing and assembly occur at a fabrication site owned or operated by a wearable article brand company 103. At retail site 101 a customer 1 and a retail technician 2 meet in the customer service facility, and technician 2 acquires 402 a data set that profiles a body portion of customer 1. Once a digital data set profiling the customer has been acquired, it is sent 403 to service provider 102 for processing by system 40. There, it is received and becomes data input 41, as shown in FIG. 1. Service provider 102 has an operating arrangement or agreement 112 with branded wearable article manufacturer and marketer 103. Within system 40 of service provider 102, input is processed into output 45 that includes manufacturing instructions 44. Service provider 102 then sends (Step 405) manufacturing instructions to the fabrication facility 110B owned by brand wearable article company 103.

Fabrication site 110B includes inventory 20 of parts or components 22 (as shown in FIG. 2) that are required for fabrication of a custom-fitted wearable article 26. Within fabrication facility 110A, components 22 that are appropriate per manufacturing instructions are conveyed into a rapid manufacturing machine 10 (see FIG. 2) for processing into a desired form. Fabrication and assembly steps within fabrication facility 110A are substantially the same as those described in the fabrication facility, as shown in FIG. 2. Through the combined activity of rapid manufacturing machinery and product assembly within fabrication facility 110B, a complete article 26 is manufactured and then conveyed (Step 411) to the retail facility 101, where it delivered to customer 1.

FIG. 5 depicts a mass customization method and system embodiment where manufacturing and assembly occur at a mobile factory or station 110M, such as but not limited to a bus, a truck, van, a cart, or any suitable mobile platform. At retail site 101, a customer 1 and a retail technician 2 meet, and technician 2 acquires 502 a data set that profiles a body portion of customer 1. Once a digital data set profiling the customer has been acquired, it is sent 503 to service provider 102 for processing by system 40. There, it is received and becomes data input 41, as shown in FIG. 1. Service provider 102 has an operating arrangement or agreement 112 with branded wearable article manufacturer and marketer 103. Within system 40 of service provider 102, input is processed into output 45 that includes manufacturing instructions 44. Service provider 102 then sends 505 manufacturing instructions to fabrication facility 110M, which may be owned by brand wearable article company 103.

Fabrication site 110M includes inventory 20 of parts or components 22 (as shown in FIG. 2) that are required for fabrication of a custom-fitted wearable article 26. Within fabrication facility 110M, components 22 that are appropriate per manufacturing instructions are conveyed into a rapid manufacturing machine 10 (see FIG. 2) for processing into a desired form. Fabrication and assembly steps within fabrication facility 110M are substantially the same as those described in the fabrication facility, as shown in FIG. 2. Through the combined activity of rapid manufacturing machinery and product assembly within fabrication facility 110M, a complete article 26 is manufactured and then conveyed (Step 511) to the retail facility 101, where it delivered to customer 1.

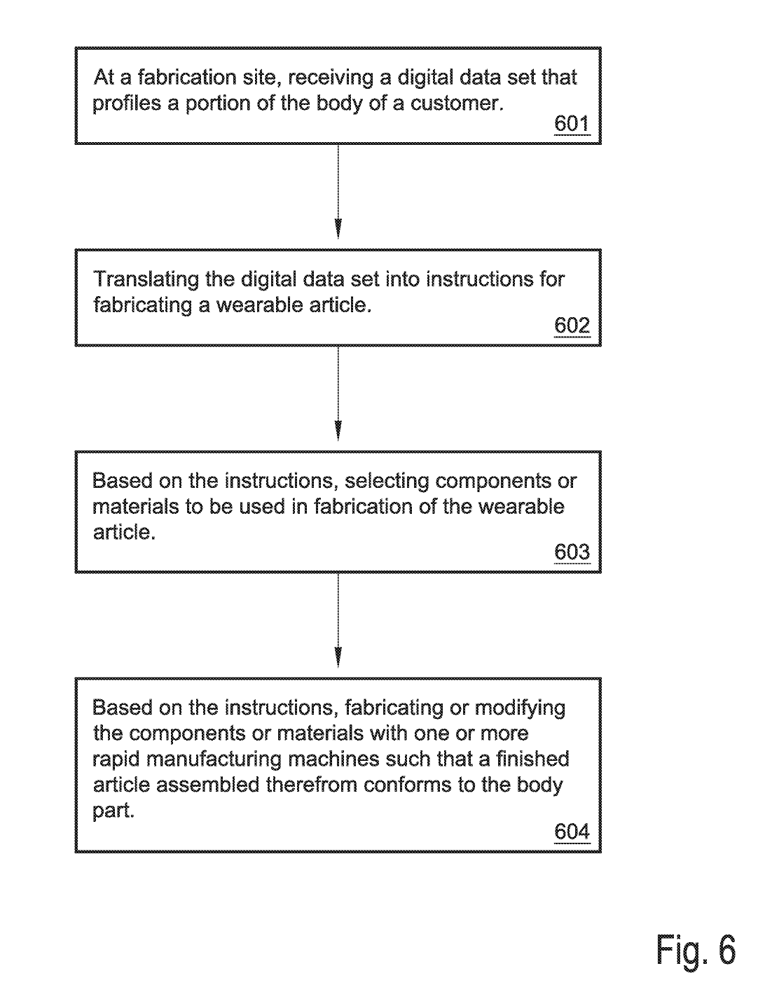

FIGS. 6-10 are flow diagrams of various embodiments of a method of fabricating and delivering a custom-fitted article to a customer. FIG. 6 is a flow diagram of a method providing a customized wearable article to a customer, where the wearable article substantially conforms to at least a portion of a body part of the customer. As described above, the method may include the participation of several cooperatively engaged business entities, and operations may be distributed over several sites, as described above. The method, in this embodiment, includes a fabrication site or factory receiving a digital data set that profiles a portion of the body of a customer 601 and translating the digital data set into instructions for fabricating a wearable article 602. Based on those instructions, the method further includes selecting components or materials to be used in fabrication of the wearable article 603, and further based on the instructions, fabricating or modifying the components or materials with one or more rapid manufacturing machines, such that a finished article assembled therefrom conforms to the body part 604.

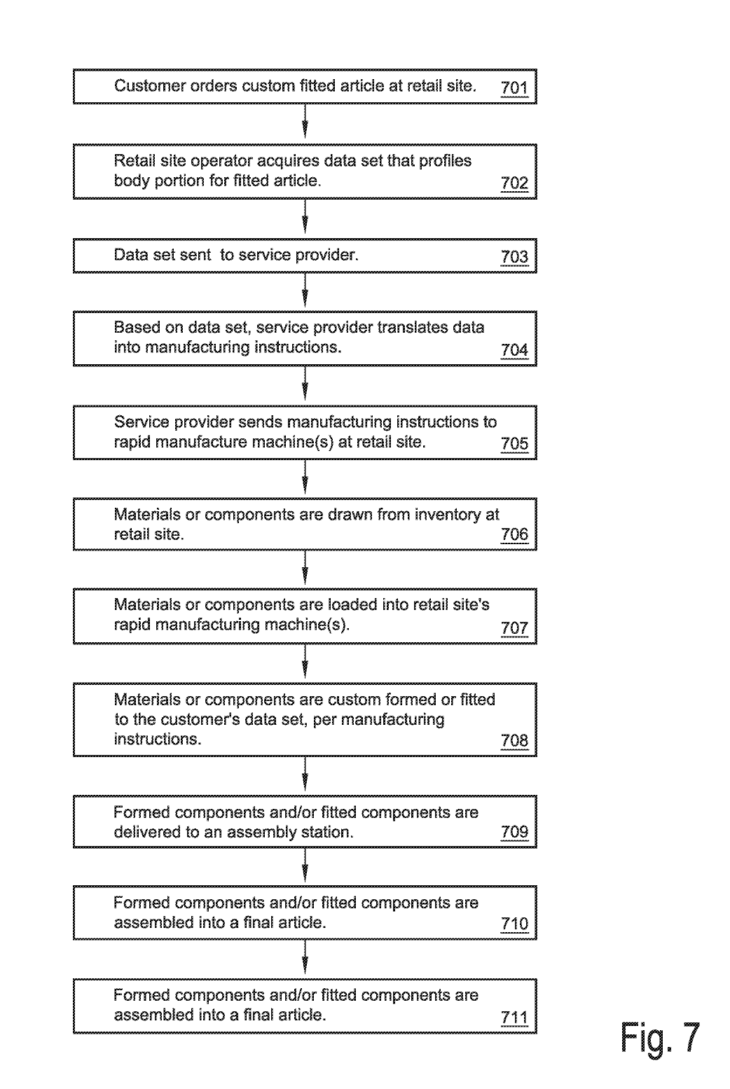

Referring now to FIG. 7, in one embodiment, a retail site, in addition to being the site where customers are custom fitted for a wearable article, is also where manufacture and assembly of the wearable article occurs. FIG. 7 is a flow diagram of a method for fabricating a wearable article that has a high degree of conformal fit to a body part of a customer. This particular embodiment is one wherein at least some portion of fabrication or assembly of the final wearable article occurs at a retail site. This retail site is generally the same, or at least is related to, the site where the customer first engages the provided technology, and where the body part for which the wearable article is intended as digitally profiled. In the depicted embodiment, the method involves the following steps:
1. Customer orders custom fitted article at retail site (701).
2. Retail site operator acquires data set that profiles body portion for fitted article (702).
3. Data set sent to service provider (703).
4. Based on data set, service provider translates data into manufacturing instructions (704).
5. Service provider sends manufacturing instructions to rapid manufacture machine(s) at retail site (705).
6. Materials or components are drawn from inventory at retail site (706).
7. Materials or components are loaded into retail site's rapid manufacturing machine(s) (707).
8. Materials or components are custom formed or fitted to the customer's data set, per manufacturing instructions (708).
9. Formed components and/or fitted components are delivered to an assembly station (709).
10. Formed components and/or fitted components are assembled into a final article (710).
11. Custom fit article is delivered to the customer (711).

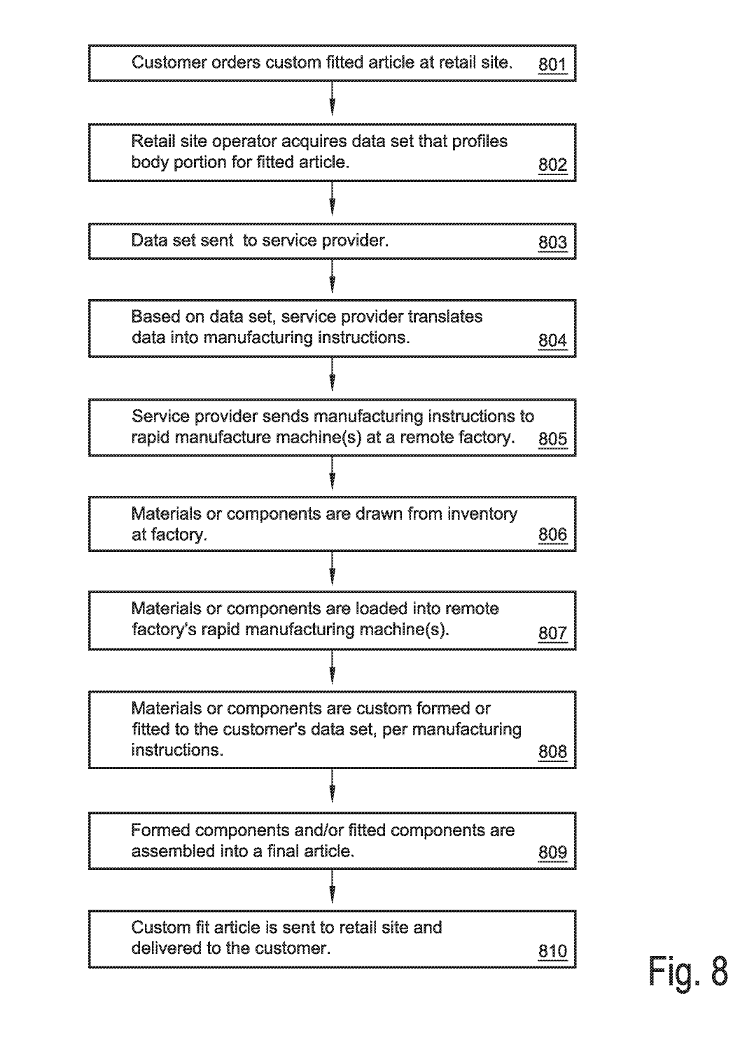

Referring now to FIG. 8, in one embodiment, fabrication of a fitted wearable article occurs in a fabrication facility that is remote from the retail site and that may be independent of the brand wearable article manufacturer, operating under a contract. FIG. 8 is a flow diagram of a method for fabricating a wearable article that has a high degree of conformal fit to a body part of a customer. In the depicted embodiment, the method involves the following steps:
1. Customer orders custom fitted article at retail site (801)
2. Retail site operator acquires data set that profiles body portion for fitted article (802)
3. Data set sent to service provider (803)
4. Based on data set, service provider translates data into manufacturing instructions (804)
5. Service provider sends manufacturing instructions to rapid manufacturing machine(s) at a remote factory (805)
6. Materials or components are drawn from inventory at factory (806)
7. Materials or components are loaded into remote factory's rapid manufacturing machine(s) (807)
8. Materials or components are custom formed or fitted to the customer's data set, per manufacturing instructions (808)
9. Formed components and/or fitted components are assembled into a final article (809)
10. Custom fit article is sent to retail site and delivered to the customer (810)

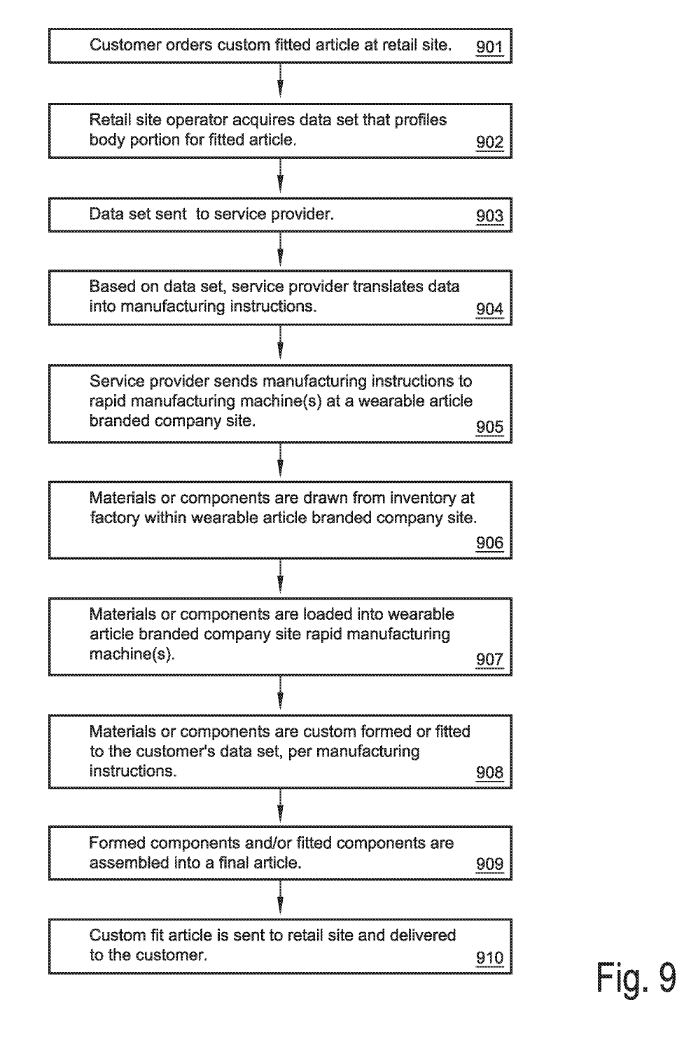

Referring now to FIG. 9, in one embodiment, fabrication of a fitted wearable article occurs in a fabrication facility owned and/or directly operated by a wearable article brand company. FIG. 9 is a flow diagram of an embodiment of a method for fabricating a wearable article that has a high degree of conformal fit to a body part of a customer. In the depicted embodiment, the method involves the following steps:
1. Customer orders custom fitted article at retail site (901).
2. Retail site operator acquires data set that profiles body portion for fitted article (902).
3. Data set sent to service provider (903).
4. Based on data set, service provider translates data into manufacturing instructions (904).
5. Service provider sends manufacturing instructions to rapid manufacturing machine(s) at a wearable article branded company site (905).
6. Materials or components are drawn from inventory at factory within wearable article branded company site (906).
7. Materials or components are loaded into wearable article branded company site rapid manufacturing machine(s) (907).
8. Materials or components are custom formed or fitted to the customer's data set, per manufacturing instructions (908).
9. Formed components and/or fitted components are assembled into a final article (909).
10. Custom fit article is sent to retail site and delivered to the customer (910).

As described above, FIG. 5 is a pictographic diagram for a method custom fitting sports equipment and rapid manufacture at mobile facility or platform such as a van, truck, or bus that can be located at or near a retail site. By way of example, in one embodiment, the mobile site could be a van that travels to the site of an athletic event, and by such location, the mobile site can readily serve a number of customers quickly and efficiently. This embodiment is described above and shown in pictographic diagram FIG. 5.

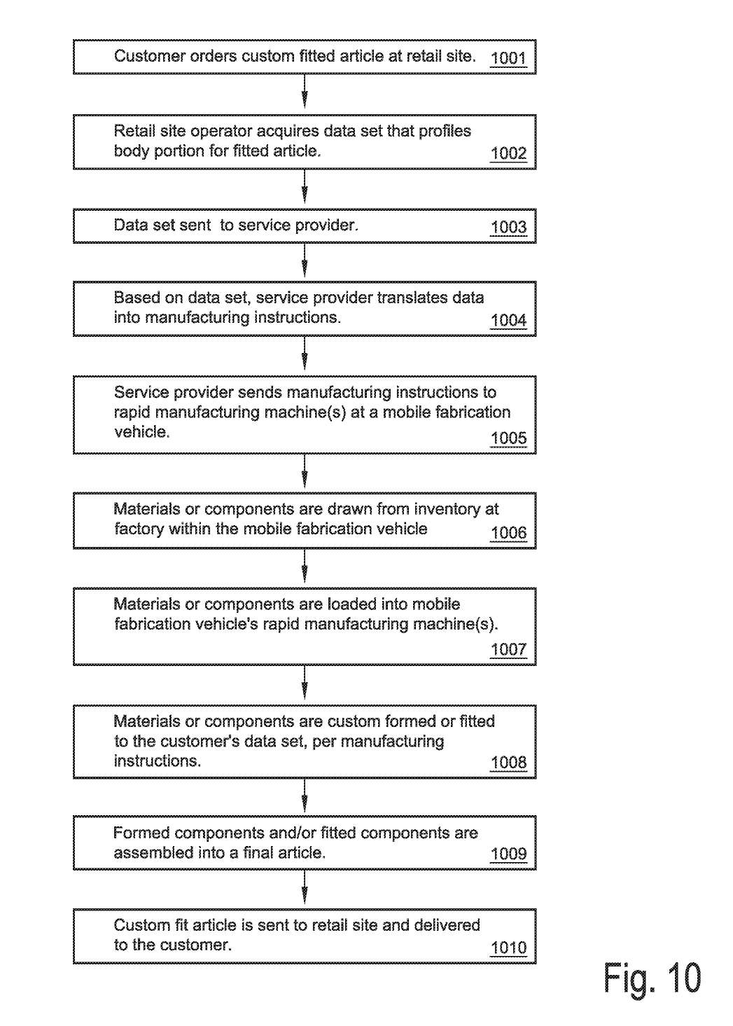

FIG. 10 is a flow diagram of another embodiment of a method for fabricating a wearable article that has a high degree of conformal fit to a body part of a customer. In the depicted embodiment, the method involves the following steps:
1. Customer orders custom fitted article at retail site (1001).
2. Retail site operator acquires data set that profiles body portion for fitted article (1002).
3. Data set sent to service provider (1003).
4. Based on data set, service provider translates data into manufacturing instructions (1004).
5. Service provider sends manufacturing instructions to rapid manufacturing machine(s) at a mobile fabrication vehicle (1005).
6. Materials or components are drawn from inventory at factory within the mobile fabrication vehicle (1006).
7. Materials or components are loaded into mobile fabrication vehicle's rapid manufacturing machine(s) (1007).
8. Materials or components are custom formed or fitted to the customer's data set, per manufacturing instructions (1008).
9. Formed components and/or fitted components are assembled into a final article (1009).
10. Custom fit article is transferred to retail site and delivered to the customer (1010).

Any one or more features of any embodiment disclosed herein (method or system) may be combined with any one or more other features of any other embodiment, without departing from the scope of the invention. The invention is not limited to the embodiments described or depicted herein for purposes of exemplification, but is to be defined only by a fair reading of claims appended to the patent application, including the full range of equivalency to which each element thereof is entitled.

What is claimed is:

1. A method of fabricating a wearable article for a customer, wherein the wearable article substantially conforms to a portion of a body part of the customer, the method comprising:
receiving an acquired data set that defines a three-dimensional digital profile of the portion of the body part;
translating the digital set into instructions for fabrication of the wearable article; and
sending the instructions for fabrication of the wearable article to a fabrication site,
wherein the instructions are operable for selecting one or more components or materials from one or more inventories to be used in the fabrication of the wearable article, and
wherein the instructions are operable for fabricating or reshaping the components or materials through implementation of a rapid manufacturing machine, such that a finished article assembled therefrom substantially conforms to the portion of the body part.

2. A method as in claim 1, further comprising, prior to receiving the digital data set at the fabrication site, profiling the portion of the body part at a retail site to create the acquired digital data set.

3. A method as in claim 1, wherein the fabrication site is selected from the group consisting of a retail site, a remote site, a site owned by a wearable article brand, and a mobile site.

4. A method as in claim 3, wherein the fabrication site is owned by a brand manufacturer of wearable articles.

5. A method as in claim 3, wherein the fabrication site is owned by a party other than a brand manufacturer.

6. A method as in claim 1, further comprising reshaping the components or the materials, according to the instructions.

7. A method as in claim 1, further comprising assembling the one or more components or materials into a complete wearable article that substantially conforms to the body part of the customer.

8. A method as in claim 7, wherein assembling the one or more components or materials into a complete wearable article that substantially conforms to the body part of the customer occurs at a fabrication site selected from the group consisting of a retail site, a remote site, and a mobile site.

9. A method as in claim 1, further comprising delivering the complete wearable article to the customer.

10. A method as in claim 1, wherein the rapid manufacturing machine is operable by a CNC machine, operating from manufacturing instructions that specify a configuration of an actuatable pin-based surface.

11. A method as in claim 1, wherein the rapid manufacturing machine comprises an actuatable pin-based surface, wherein each of the pins is independently actuatable by a motor proximate the pin.

12. A method as in claim 1, wherein the rapid manufacturing machine comprises an actuatable surface capable of complying with the instructions to form a surface that is conformal or complementary to the three-dimensional digital profile of the portion of the body part.

13. A method as in claim 12, wherein the instructions are modifiable by biomechanically-informed input that directs divergence from a reshaped surface that is strictly conformable or complementary to one that is biomechanically appropriate for the wearer.

14. A system for delivering a wearable article to a customer, wherein the wearable article substantially conforms to at least a portion of a body part of the customer, the system comprising:
a data storage device operable by a service provider for storing instructions for selecting customer-specific wearable article components from an inventory; and
a processor operable by a service provider and configured to execute the instructions to perform a method, the performed method comprising:
receiving an acquired data set that defines a three-dimensional digital profile of the portion of the body part;
translating the digital set into instructions for fabrication of the wearable article; and
sending the instructions for fabrication of the wearable article to a fabrication site,
wherein the instructions are operable for selecting one or more components or materials from one or more inventories to be used in the fabrication of the wearable article, and
wherein the instructions are operable for fabricating or reshaping the components or materials through implementation of a manufacturing machine, such that a finished article assembled therefrom substantially conforms to the portion of the body part

15. A system as in claim 14, further comprising an inventory of components or materials for assembling the wearable article, the assembling based at least in part on the digital profile of the portion of the body part,

16. A system as in claim 14, wherein the method, prior to receiving the digital data set, further comprises profiling the portion of the body part at a retail site to acquire the digital data set.

17. A system as in claim 14, wherein the fabrication site is selected from the group consisting of a retail site, a remote site, a site owned by a wearable article brand, and a mobile site.

18. A system as in claim 17, wherein the fabrication site is owned by a brand manufacturer of wearable articles.

19. A system as in claim 17, wherein the fabrication site is owned by a party other than the brand manufacturer.

20. A system as in claim 14, wherein the method performable by the system further comprises assembling the one or more components or materials into a complete wearable article that substantially conforms to the body part of the customer.

21. A system as in claim 20, wherein assembling the one or more components or materials into a complete wearable article that substantially conforms to the body part of the customer occurs at a fabrication site selected from the group consisting of a retail site, a remote site, and a mobile site.

22. A system as in claim 14, wherein the method performable by the system further comprises delivering the complete wearable article to the customer.

23. A system as in claim 14, wherein the rapid manufacturing machine comprises an actuatable surface capable of complying with the instructions to form a surface that is conformal or complementary to the three-dimensional digital profile of the portion of the body part.

24. A system as in claim 14, wherein the rapid manufacturing machine is operable by a CNC machine, operating from manufacturing instructions that specify a configuration of a an actuatable pin-based surface.

25. A system as in claim 24, wherein the instructions are modifiable by biomechanically-informed input that directs divergence from a reshaped surface that is strictly conformable or complementary to one that is biomechanically appropriate for the wearer.

26. A system as in claim 14, wherein the rapid manufacturing machine comprises an actuatable pin-based surface, wherein each of the pins is independently actuatable by a motor proximate the pin.
